(19) United States
(12) Patent Application Publication
(10) Pub. No.: US 2024/0294037 A1
(43) Pub. Date: Sep. 5, 2024

(54) REMOVABLE WORK BOX CASTER

(71) Applicant: Timothy J. Heinzen, Lafayette, LA (US)

(72) Inventor: Timothy J. Heinzen, Lafayette, LA (US)

(21) Appl. No.: 18/177,062

(22) Filed: Mar. 1, 2023

(51) Int. Cl. B60B 33/00

(52) U.S. Cl. CPC B60B 33/0018; B60B 33/0005; B60B 33/0021; B60B 33/0068; B60B 33/0039

(57) ABSTRACT

Removable work box casters for a job site work box having support skids comprised of an open polygonal shaped frame having a skid base plate and skid side plates. Each caster has an upper plate segment, a closed end section, a lower plate segment that creates a sleeve between the upper and lower plate segments, and a wheel assembly. The skid base plates of the skids are positioned within the sleeve of a selected removable work box caster. A security device may be included to assist in retaining the skid base plate within the sleeve of the removable work box caster.

### FIELD OF INVENTION

This invention generally relates to casters and, more particularly, to a removable caster for a job site work box.

### BACKGROUND OF THE INVENTION

Job site work boxes also called construction boxes are utilized to store tools and equipment used at construction sites and manufacturing facilities. These boxes are typically constructed of heavy gauge metal plate and may be difficult or inconvenient to move particularly when the boxes are filled with tools or other equipment. Many job site work boxes have support feet or skids that support and raise the boxes above floor or ground level.

In many instances, the skids of such job site work boxes are comprised of plates configured as open trapezoidal shaped frames. Examples of job site work boxes with skids comprised of such open trapezoidal shaped frames include the KNAACK® job site storage units manufactured by Werner Co., 93 Werner Road, Greenville Pennsylvania 16125 and the Model #2048-NTE job site box manufactured by Northern® Tool+Equipment, 2800 Southcross Drive West, Burnsville, Minnesota 55306.

Job site work boxes are often difficult to move or relocate due to the weight of the box itself and the added weight of the items typically stored in such boxes. Moving the job site work boxes often requires the use of hoists, forklifts, or dollies and hand trucks. Such equipment may not be readily available when there is a necessity to adjust the position of a job site work box. Permanently placed casters as a supports are sometimes utilized as a solution to the problems associated with relocation of a job site work box. However, permanent casters, event those with wheel brakes, sometime are easily shifted or moved. Such movement may create safety hazards resulting personal injury and property damage, if a job site work box is inadvertently shifted in a pathway or from a support surface such as a truck bed. In many situations, caster will need to be removed from a job site work box to minimize the problems associated with shifting or rolling caster supports.

Temporary wheels or caster devices have been proposed as supports for a variety of container structures. One such temporary caster as that disclosed in U.S. Pat. No. 9,707,802 B1 which provides for an attachment plate attached to the base of a container or carrier. The attachment plate has parallel grooves for slidably receiving a mounting plate upon which a caster is attached. Another such temporary caster device is disclosed in U.S. Pat. No. 8,302,256 B1 which provides a housing mounted to the container or carrier. The housing has opposing U-shaped channels for receiving a mounting plate attached to a caster. A pin is used as a secure and release the mounting plate.

There are problems associated with such temporary caster designs. The attachment plates and housing of such devices typically require providing a plate structure with opposing channels or grooves for attachment of the caster plate. The attachment plates or housing must be separately mounted to the container or carrier. Such features increase the cost of manufacture and require multiple components to be installed. In many instances, these devices are not robust enough to serve as a temporary caster for a job site box and making them so would increase the cost of their use.

Consequently, there is a need for a removable caster for a job site work box that is inexpensive to manufacture, that is readily attached to the supports or skids of the job site work box, and that is readily removable from the supports or skids of a job site work box.

### SUMMARY OF THE INVENTION

The present invention is a removable work box caster designed to satisfy the aforementioned needs. It consist of a flat plate that is folded over upon itself to create a sleeve comprised of an upper plate segment and a lower plate segment. The sleeve is configured to receive the base plate of a polygonal shaped skid or support plate such as a skid or support comprised of a plate or plates arranged as an open trapezoidal shaped frame or an open rectangular shaped frame. A caster wheel is attached to the underside of the lower plate segment. A security device is provided to retain the base plate of the skid within the sleeve created by the upper and lower plate segments. While other security devices may be utilized such as a hasp and loop or one or more bolts with corresponding nuts, a cotter pin is thought to be sufficient.

For use, the sleeve of a removable work box caster is inserted over each base plate of each of the skids of a job site work box so that the caster wheels are under the skid base plate. Once so inserted the removable work box caster is held in place by one or more cotter pins inserted in pin holes in the upper and lower plate segments. Use of the removable work box caster described herein requires no modification of the job site work box with which it is to be used. Further, Use of the removable work box caster described herein there is no attachment of any associated fixture such as a mounting plate.

### BRIEF DESCRIPTION OF DRAWINGS

FIG. 1 is a schematic perspective view of a typical job site work box.

FIG. 2 is perspective view of the removable work box caster of applicant's invention.

FIG. 3 is a front end view of the removable work box caster shown in FIG. 2.

FIG. 4 is a side end view of the removable work box caster shown in FIG. 2.

FIG. 5 is a schematic perspective view illustrating the insertion of the removable work box casters of FIG. 2 onto the support skids of the job site work box shown in FIG. 1.

FIG. 6 is a schematic side view of the job site work box shown in FIG. 1 showing the removable work box casters of FIG. 2 mounted onto the support skids of the job site work box.

FIG. 7 is a partial cross-section view cut on section line 7-7 of FIG. 6 showing a detail view of the removable work box caster mounted onto a support skid of the job site work box shown in FIG. 1.

### DETAILED DESCRIPTION OF THE INVENTION

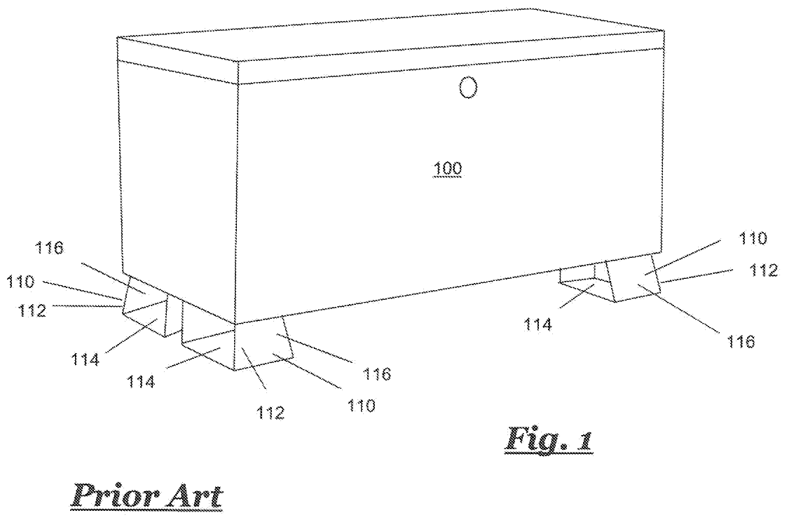

FIG. 1 one shows a perspective view of a typical job site work box (100) for which the removable work box casters (10) are to be utilized. The work box (100) is supported on skids (110) that are comprised of a plate or plates formed to create an open polygonal shaped frames (112) having a skid base plate (114) and skid side plates (116). One or more skids (110) may be utilized to support the work box (100). The skids in FIG. 1 are shown as a trapezoidal shaped frame but the skids may be comprised of a plate or plates of any suitable polygonal shape such as a triangle shape.

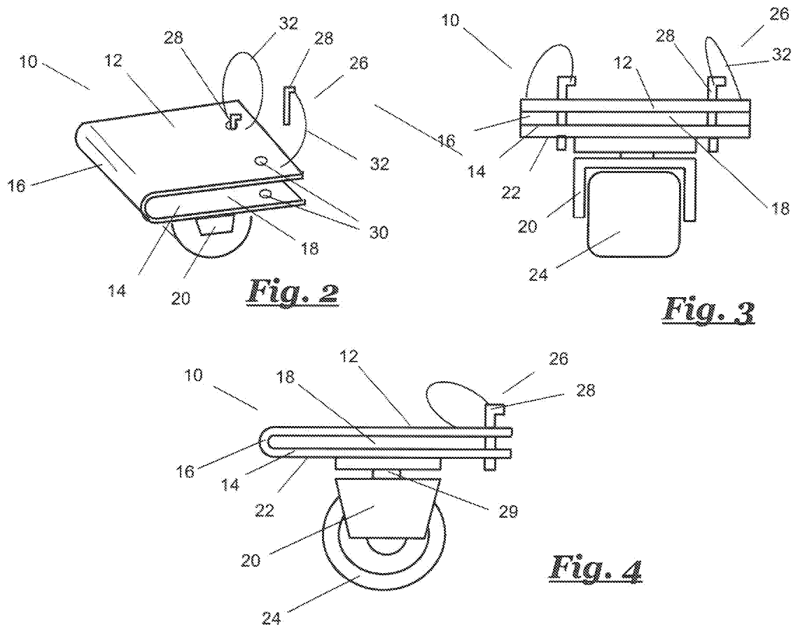

The removable work box caster (10) of applicant's invention is shown in FIGS. 2-4. The removable work box caster (10) is comprised of an upper plate segment (12), a lower plate segment (14), a closed end section (16), and a sleeve (18) created between the upper plate segment (12) and the lower plate segment (14). Preferably, the removable work box caster (10) will be comprised on a single plate that is folded over upon itself to create the upper plate segment (12), the lower plate segment (14), the end section (16), and the sleeve section (18). However, the upper plate segment (12), the lower plate segment (14), the end section (16) may be formed from multiple plates that are welded or otherwise connected together.

The sleeve (18) the upper plate segment (12) and the lower plate segment (14) is configured to receive the base plate (114) of skid frame (112). A pivotable wheel assembly (20) is mounted to the underside (22) of the lower plate segment (14). The wheel assembly (20) will preferably have a wheel (24) that rotates horizontally 360 degrees about a vertically extending wheel assembly shaft (29). A security device (26) is provided to retain the base plate (114) of the skid frame (112) of the skid (110) within the sleeve (18) created by the upper plate segment (12) and the lower plate segment (14). The security device (26) is shown as a removable cotter pin (28) positioned in cotter pin holes (30) in the upper plate segment (12) and the lower plate segment (14). The cotter pin (28) may be attached to a pin cord (32) that is attached to the upper plate segment (12) as a convenient way to retain the pin (30) when it is removed. The pin cord may be wire, a cable, string, or a chain. Other security devices may be utilized such as a hasp and loop or one or more bolts with corresponding nuts.

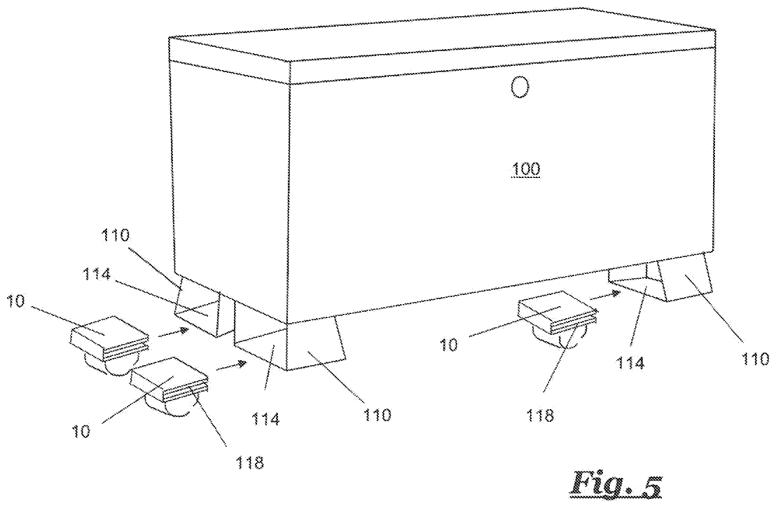

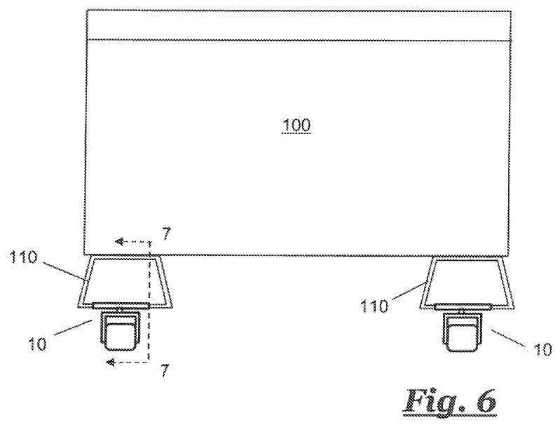

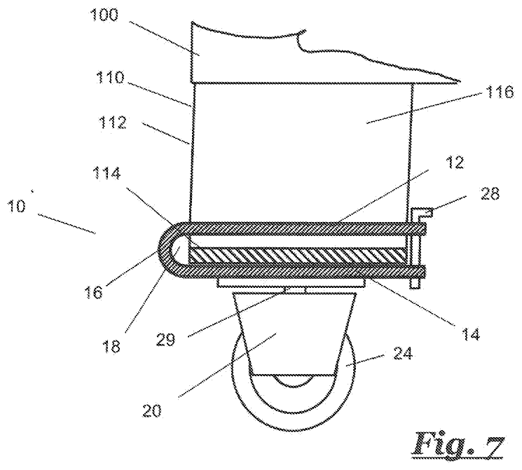

FIG. 5 shows a schematic view of the installation of the removable work box caster (10) on the skids (110) of a work box (100). For use, a removable work box caster (10) is provided for each skid (110) of a work box (100). The sleeve (18) of a selected removable work box caster (10) is then inserted over the base plate (114) of each skid (110) of the work box (100) so that each base plate (114) is positioned between the upper plate segment (12) and the lower plate segment (14) of a removable work box caster with the respective wheel assembly (20) and wheel (24) of the selected work box caster (10) positioned beneath each of the skid base plates (114). FIG. 6 shows a schematic view of the work box (100) with the mounted removable work box casters (10) mounted onto the skids (110). FIG. 7, a partial cross-section view from section 7-7 of FIG. 6, shows a cross-section schematic view of a removable work box caster (10) mounted on the skid (110) of the work box (100).

Once the sleeves (18) of the removable work box caster (10) are so positioned, each of the removable work box caster (10) may be then held in place around the skid base plates (114) by the latching mechanism (26) such as one or more cotter pins (28) inserted in pin holes (30) in the upper and lower plate segments. The removable work box caster (10) may be readily removed from the job site work box (100) by pulling the cotter pin or pins (28) and sliding the sleeve (18) off of the skid base plates (114).

It is thought that the removable work box caster (10) and method of the present invention and many of its attendant advantages will be understood from the foregoing description and it will be apparent that various changes may be made in the form, construction and arrangement of the parts thereof without departing from the spirit and scope of the invention or sacrificing all of its material advantages, the form described herein being merely a preferred or exemplary embodiment of the invention.

1. In combination with a job site work box supported on skids, said skids comprised of an open polygonal shaped frame having a skid base plate and skid side plates, a removable work box caster comprising:
(a) an upper plate segment, a lower plate segment, and a closed end section;
(b) a sleeve between said upper plate segment and said lower plate segment;
and
(c) a wheel assembly attached to said lower plate segment.

2. The combination recited in claim 1 wherein said removable work box caster has a security device whereby said skid base plate is retained within said sleeve.

3. The combination recited in claim 2 wherein said security device is comprised of a removable pin positioned through said upper plate segment and said lower plate segment of said removable work box caster.

4. The combination recited in claim 3 further comprising a cord attaching said removable work box caster to said removable pin.

5. The combination recited in claim 2 wherein said upper plate segment, said lower plate segment and said closed end section are comprised of a single continuous plate.

6. Removable work box casters for a job site work box comprising:
(a) a job site work box supported on a plurality of skids, each of said skids comprised of an open polygonal shaped frame having a skid base plate and skid side plates;
(b) a plurality of removable work box casters, each said caster of said plurality of casters comprising an upper plate segment, a closed end section, and a lower plate segment having a bottom surface, a wheel assembly attached to said bottom surface of said lower plate segment, and a sleeve between said upper plate segment and said lower plate segment; and
(c) wherein said skid base plate of each of said skids is positioned within said sleeve of a selected removable work box caster selected from said plurality of removable work box casters.

7. The removable work box casters recited in claim 6, further comprising a security device retaining skid base plates of each of said skids within said sleeve of said selected work box caster.

8. The removable work box casters recited in claim 7 wherein said security device is comprised of a pin positioned through a pin hole in said upper plate segment and said lower plate segment of each of said work box casters.

9. The removable work box casters recited in claim 8 further comprising a pin cord attached to said pin and each said removable work box caster of said a plurality of removable work box casters.

14. The removable work box casters recited in claim 6 wherein each said wheel assembly has a wheel that rotates 360° horizontally.

10. A method of adding removable work box casters to a job site work box comprising:
(a) providing a job site work box supported on a plurality of skids, each of said skids of said job site work box comprised of an open polygonal shaped frame having a skid base plate and skid side plates;
(b) providing a plurality of removable work box casters, each removable work box caster of said caster of said plurality of casters comprising an upper plate segment, a closed end section, and a lower plate segment having a bottom surface, a wheel assembly attached to said bottom surface of said lower plate segment, and a sleeve between said upper plate segment and said lower plate segment;
(c) selecting a said removable work box caster from said plurality of removable work box casters;
(d) sliding said sleeve of said selected removable work box caster onto said skid base plate of a selected skid of said job site work box with said lower plate segment positioned below said skid base plate of said selected skid; and
(e) repeating steps (c) and (d) until a said removable work box caster is mounted onto each said skid of said job site work box.

11. The method of adding removable work box casters to a job site work box recited in claim 10 further comprising providing a security device attached to each said removable work box caster whereby said skid base plate of each of said skids is retained within said sleeve of a said selected work box caster.

12. The method of attaching removable work box casters to a job site work box recited in claim 11 wherein said security device is comprised of at least one pin positioned through a pin hole in said upper plate segment and said lower plate segment of each said selected removable work box caster

13. The method of attaching removable work box casters to a job site work box recited in claim 12 further comprising the step of providing a pin cord attached to each said pin and each said selected removable work box caster.
